(19) United States
(12) Patent Application Publication
(10) Pub. No.: US 2016/0147257 A1
(43) Pub. Date: May 26, 2016

(54) CARBON FIBER REINFORCED SHAPED PRODUCT INCLUDING METAL PLATE AND MANUFACTURING METHOD THEREOF

(71) Applicant: Kabushiki Kaisha Toshiba, Tokyo (JP)

(72) Inventor: Fuminori Yamazaki, Fussa Tokyo (JP)

(21) Appl. No.: 14/722,469

(22) Filed: May 27, 2015

Related U.S. Application Data
(60) Provisional application No. 62/084,850, filed on Nov. 26, 2014.

(51) Int. Cl. G06F 1/16; B29C 70/70; B29C 70/68; C08J 5/04

(52) U.S. Cl. CPC G06F 1/1613; C08J 5/042; B29C 70/70; B29C 70/682; C08J 2300/22; B29K 2101/12

(57) ABSTRACT

According to one embodiment, a carbon fiber reinforced shaped product including a metal plate has a flat plate and at least one projection. The flat plate is formed of a sheet material including a carbon fiber reinforced thermoplastic resin, and includes a first flat surface and a second flat surface. The at least one projection is formed of a thermoplastic resin from the sheet material. The flat plate includes a metal plate provided therein and covering a flat area corresponding to the at least one projection.

### CROSS-REFERENCE TO RELATED APPLICATIONS

This application claims the benefit of U.S. Provisional Application No. 62/084,850, filed Nov. 26, 2014, the entire contents of which are incorporated herein by reference.

### FIELD

Embodiments described herein relate generally to a carbon fiber reinforced shaped product including a metal plate, and a manufacturing method thereof.

### BACKGROUND

In general, electronic devices, such as computers, personal computers and information terminals, use shaped products formed of a carbon fiber reinforced composite, to make them light and rigid. To realize further light weight of these devices, the shaped products have been made thinner. In this case, to maintain appropriate rigidity, the products have thick portions, such as ribs and bosses.

There is a known method of forming ribs and bosses on a carbon fiber reinforced shaped composite product including a thermo-setting resin, by outsert-molding and injection using a thermoplastic resin, and applying an adhesive to the resultant structure to enhance the adhesion of the interface between the carbon fiber reinforced composite of the product and the ribs or bosses. However, a large amount of resin exists at the interface between the carbon fiber reinforced composite and the thermoplastic resin forming the ribs or bosses. Therefore, the known method is disadvantageous in reducing the weight and thickness of the product.

Further, a method of forming ribs, bosses and claws simultaneously with the molding of carbon fiber, using a thermoplastic carbon fiber reinforced composite has been developed. Since the carbon fiber reinforced composite has a higher rigidity than other general thermoplastic resins, it enables shaped products to be made thinner. The use of the carbon fiber reinforced composite, however, may easily cause sink marks to occur on counter surfaces.

As a technique of preventing occurrence of sink marks, a method of, for example, forming ribs using a reinforced fiber mat, and providing, as a sink-mark preventing sheet, a foamed sheet having closed cells laid down above the reinforced fiber mat is known.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a cross-sectional view showing an example of a carbon fiber reinforced shaped product including a metal plate, according to an embodiment;

FIGS. 2A, 2B, 2C and 2D are schematic cross-sectional views for explaining a process sequence of manufacturing the example of the carbon fiber reinforced shaped product with the metal plate according to the embodiment;

FIGS. 3A, 3B and 3C are schematic cross-sectional views for explaining another process sequence of manufacturing the example of the carbon fiber reinforced shaped product with the metal plate according to the embodiment;

FIG. 4A is a plan view showing the example of the carbon fiber reinforced shaped product with the metal plate according to the embodiment;

FIG. 4B is a cross-sectional view showing the example of the carbon fiber reinforced shaped product with the metal plate according to the embodiment;

FIG. 5 is a cross-sectional view showing another example of the carbon fiber reinforced shaped product with the metal plate according to the embodiment; and

FIG. 6 is a perspective view of an example of a notebook computer (PC) as an article provided with a carbon fiber reinforced shaped product including a metal plate, showing a state in which the display unit of the PC is open.

### DETAILED DESCRIPTION

Various embodiments will be described hereinafter with reference to the accompanying drawings. The drawings are merely schematic and are not to scale.

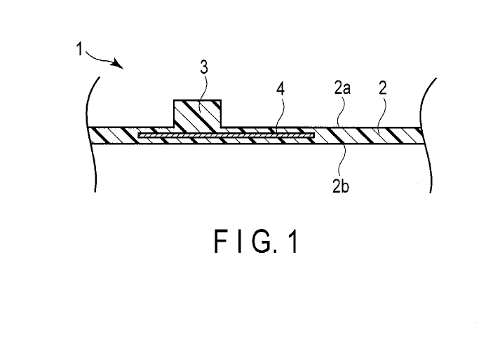

FIG. 1 is a cross-sectional view showing an example of a carbon fiber reinforced shaped product according to the embodiment. A carbon fiber reinforced shaped product 1 comprises a flat plate 2, at least one projection 3 and a metal plate 4. The flat plate 2 is formed of a sheet material containing a carbon fiber reinforced thermoplastic resin, and has first flat surface 2a and second flat surface 2b. The projection 3 projects from the second flat surface 2a of the flat plate 2. Further, the projection 3 is formed of the thermoplastic resin from the sheet material. The metal plate 4 is buried in the flat plate 2. The metal plate 4 covers a flat surface area corresponding to the at least one projection 3.

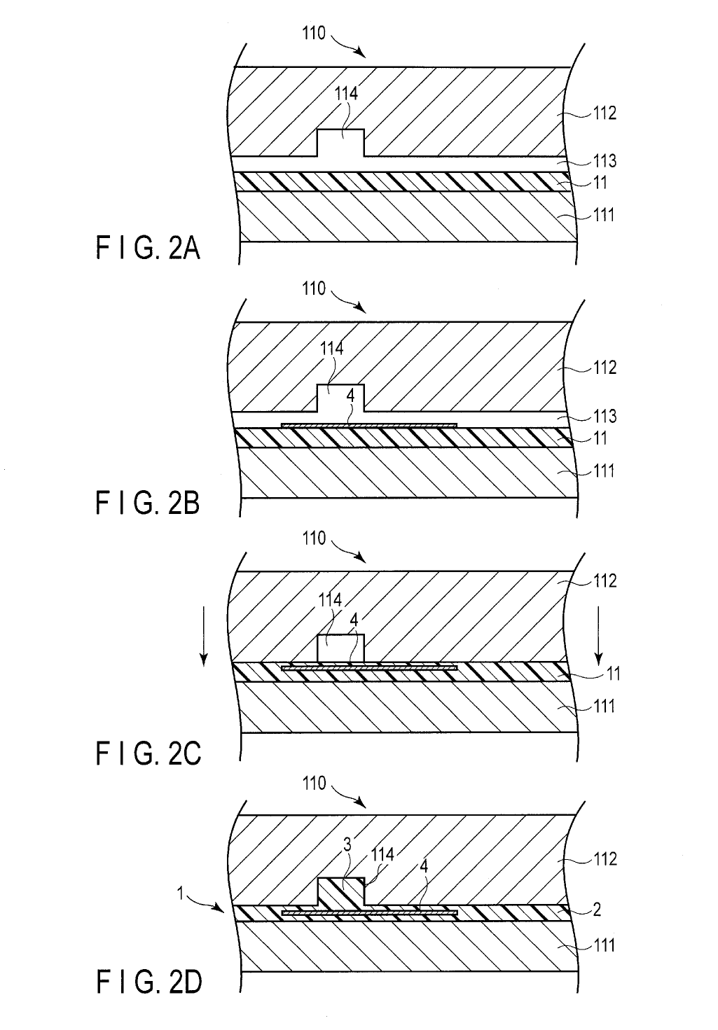

FIGS. 2A to 2D show a process sequence of manufacturing the carbon fiber reinforced shaped product according to the embodiment.

A shape-forming die 110 comprises a first die 111 and a second die 112. The inner surface of the first die 111 is formed flat. The inner surface of the second die 112 has a cavity 114 for forming a projection.

The projection-forming cavity 114 is a depression that matches the shape of the projection 3. The projection 3 may be a shield portion, such as a rib, a boss, a claw or a shielding plate.

In a method of manufacturing the carbon fiber reinforced shaped product, firstly, a sheet material 11 containing the carbon fiber reinforced thermoplastic resin is placed on the first die 111, as is shown in FIG. 2A.

It is sufficient if the carbon fiber reinforced thermoplastic resin is a thermoplastic resin containing carbon fiber. For instance, the carbon fiber reinforced thermoplastic resin preferably contains 40% to 65% by volume of carbon fiber in the thermoplastic resin.

As the carbon fiber, polyacrylonitrile carbon fiber, pitch-based carbon fiber, rayon-based carbon fiber, etc., can be exemplified. However, the carbon fiber is not limited to these, but any type of carbon fiber can be used.

The carbon fiber can have a length of 100 mm to 500 mm, and can have any form that includes one-directional continuous fiber, bidirectional fabric woven by bidirectional fiber, polyaxial fabric woven by multidirectional fiber, corded fiber, sheet fiber, mat fiber, knitted fiber, etc.

As the thermoplastic resin, polypropylene resin, polyester resin, polyamide resin, polycarbonate resin, phenol resin, phenoxy resin, polyethylene terephthalate resin, polybutylene terephthalate resin, polyimide resin, fluorine resin, a copolymer thereof, a degenerative material thereof, and a resin obtained by blending two or more resins, can be exemplified. However, the thermoplastic resin is not limited to these, but any type of thermoplastic resin can be used.

Secondly, as shown in FIG. 2B, the metal plate 4 is placed on an area of the sheet material 11 opposing the projection-forming cavity 114. After that, the first and second dies 111 and 112 are engaged with each other. By this engagement, the sheet material 11 and the metal plate 4 are received in a shape-forming cavity 113 formed in the die 110.

As the metal plate, a metal plate of aluminum or an alloy plate of an aluminum alloy can be exemplified. The thickness of the metal plate can be selected based on conditions, such as the size of a finished product including the shaped product, the thickness of the shaped product, and the place where the shaped product is used. For instance, the metal plate can have a thickness of 0.03 mm to 0.05 mm. The word “metal plate” can be replaced with “metal film.”

Subsequently, as shown in FIG. 2C, thermal press molding, where the second die is pressed against the first die while heat is applied to the dies, is executed. The heat causes the thermoplastic resin in the sheet material 11 to flow upward.

Further thermal pressing causes the thermoplastic resin to flow into the projection-forming cavity 114 as shown in FIG. 2D. After the shape-forming cavity 113 and the projection-forming cavity 114 in the shape-forming die 110 are filled with a plastic resin supplied from the carbon fiber reinforced thermoplastic resin, application of heat and pressure is stopped.

After the temperature of the die 110 is reduced, the resultant shaped product is detached from the first and second dies. Thus, the carbon fiber reinforced shaped product including the metal plate is obtained.

The flat plate of the thus-produced carbon fiber reinforced shaped product can have a total thickness of, for example, 0.4 mm to 3 mm.

The volume of the projection-forming cavity 114 can range from more than 0% to 50% of the volume of the sheet material 11. For instance, the volume of the projection-forming cavity 114 can range from more than 0 mm³ to 5000 mm³.

By virtue of the above manufacturing method, a carbon fiber reinforced shaped product with less sink marks than in the prior art can be easily manufactured.

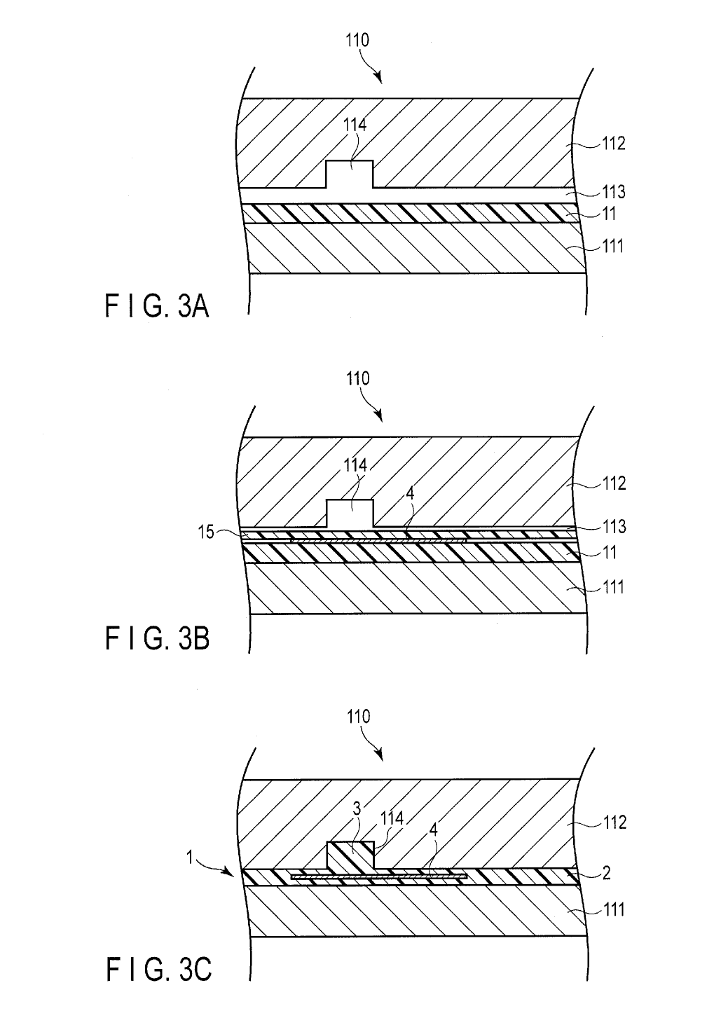

FIGS. 3A to 3C show another process sequence of manufacturing the carbon fiber reinforced shaped product of the embodiment.

As shown in FIG. 3A, a first sheet material 11 containing a carbon fiber reinforced thermoplastic resin is placed on the first die 111.

Subsequently, as shown in FIG. 3B, a metal plate 4 is placed on an area including an area of the first sheet material 11 opposing the projection-forming cavity 114. Further, a second sheet material 15 is placed on the metal plate 4.

The second sheet material 15 may contain a carbon fiber reinforced thermoplastic resin, may be the carbon fiber reinforced thermoplastic resin, may contain the same as a thermoplastic resin contained in the carbon fiber reinforced thermoplastic resin, or may be the same as a thermoplastic resin contained in the carbon fiber reinforced thermoplastic resin. Further, the second sheet material 15 can contain the same as a component of the first sheet material 11. The second sheet material 15 may be the same as the first sheet material 11 in component(s). Alternatively, the second sheet material 15 may be the same as thermoplastic resin contained in the first sheet material 11.

Further, as the second sheet material 15, a prepreg can be used. For instance, a commercially available prepreg can be used. As the commercially available prepreg, Torayca (trademark) prepreg (Toray Inc.), Tenax (trademark) prepreg (Toho Tenax Co., Ltd.), Pyrofil (trademark) prepreg (Mitsubishi Rayon Co., Ltd.), etc., are exemplified.

The second sheet material 15 can have a volume of 15,000 mm³ to 375,000 mm³. The volume of the projection-forming cavity 114 can be more than 0% to 50% of the volume of the second sheet material 15. For instance, the volume of the projection-forming cavity 114 can be more than 0 mm³ to 5000 mm³.

The first and second dies 111 and 112 are engaged with each other. By this engagement of these dies, the first sheet material 11, the metal plate 4 and the second sheet material 15 are received in a shape-forming cavity 113 formed in the die 110.

After that, as shown in FIG. 3C, thermal press molding, where the second die is pressed against the first die while heat is applied to the dies, is executed. The heat causes the thermoplastic resin in the sheet material 11 and the plastic resin in the second sheet material 15 are blended and integrated. The metal plate 4 is buried in the thermoplastic resin. Further thermal pressing causes the thermoplastic resin to flow into the projection-forming cavity 114. After the shape-forming cavity 113 and the projection-forming cavity 114 in the shape-forming die 110 are filled with the plastic resin supplied from the carbon fiber reinforced thermoplastic resin, application of heat and pressure is stopped.

After the temperature of the die 110 is reduced, the resultant shaped product is detached from the first and second dies. Thus, the carbon fiber reinforced shaped product including the metal plate is obtained.

By virtue of the above manufacturing method, a greater amount of plastic resin can be supplied into the shape-forming cavity 113 and the projection-forming cavity 114, in addition to the above-described advantage.

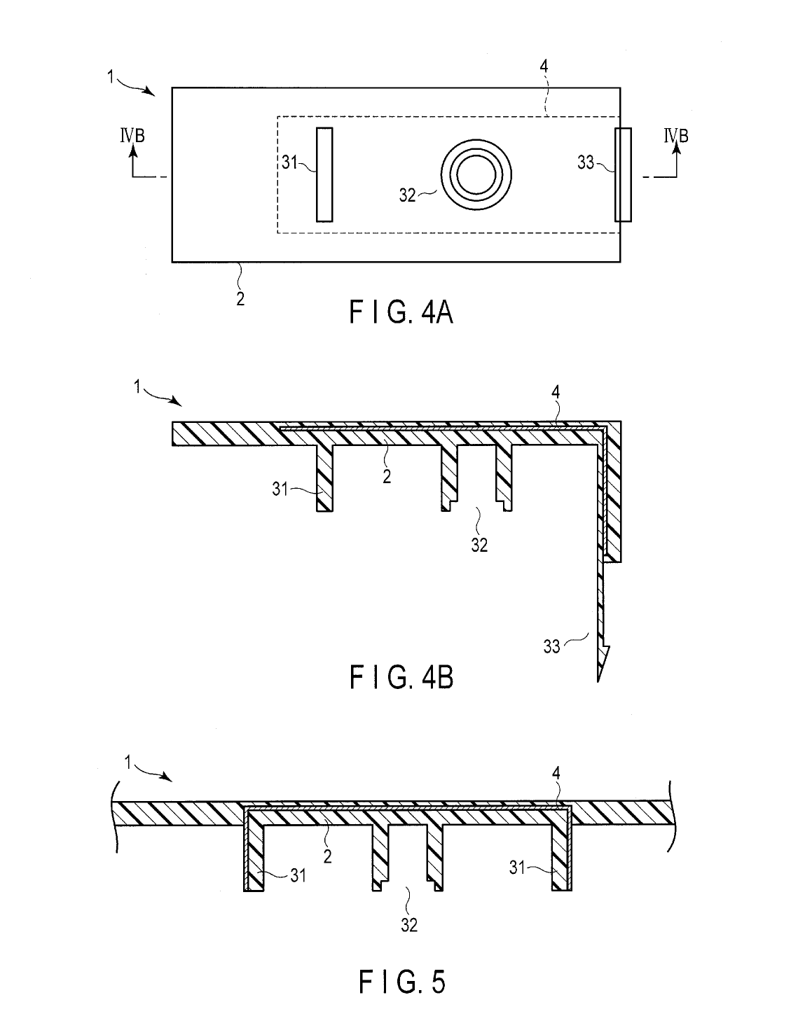

Referring then to FIGS. 4A, 4B and 5, a description will be given of yet another example of the carbon fiber reinforced shaped product of the embodiment.

FIG. 4A is a plan view showing a carbon fiber reinforced shaped product example provided with a rib 31 as a first projection, a boss 32 as a second projection, and a claw 33 as a third projection. In FIG. 4A, the area enclosed by the broken line is where a metal plate 4 is placed.

FIG. 4B is a cross-sectional view obtained when the carbon fiber reinforced shaped product 1 of FIG. 4A is viewed along line IVB-IVB of FIG. 4A. As shown in FIGS. 4A and 4B, in the carbon fiber reinforced shaped product 1 of the embodiment, the rib 31, the boss 32 and the claw 33 are linearly arranged in this order from one end to the other end. The rib 31, the boss 32 and the claw 33 substantially perpendicularly project from the second flat surface of the flat plate 2. As shown in FIG. 4B, the metal plate 4 is buried in the flat plate 2 to cover a flat area corresponding to the rib 31, the boss 32 and the claw 33.

The flat plate 2 and the metal plate 4 contained therein are angled on the claw (33) side such that their cross section will have an L-shape.

More specifically, the flat plate 2 is angled at substantially right angles on the second flat surface side thereof such that it extends along the axis of the claw 33 to substantially the half position of the claw 33. Similarly, the metal plate 4 is angled at substantially right angles on the second flat surface side of the flat plate 2, extending along the shape of the flat plate 2 along the claw 33 side. The metal plate 4 covers an area that ranges from the rib (31)-side end to the distal end of the claw 33 and includes areas corresponding to the rib 31 and the boss 32. Further, the metal plate 4 is angled at substantially right angles on the second flat surface side of the flat plate 2 such that it extends along the axis of the claw 33. The distal end of the angled portion of the metal plate 4 does not project from the flat plate 2.

The rigidity of the claw 33 can be enhanced by extending the metal plate 3 along the claw 33.

FIG. 5 shows another example of the carbon fiber reinforced shaped product according to the embodiment. FIG. 5 is a cross-sectional view of the carbon fiber reinforced shaped product 1. The carbon fiber reinforced shaped product 1 comprises a flat plate 2, a metal plate 4, a shield portion including two shielding plates 31, and a boss 32.

The two shielding plates 31 perpendicularly project from the second flat surface of the flat plate 2 respectively. The two shielding plates 31 can be positioned in respective areas to be shielded.

The boss 32 is positioned between the two shielding plates 31. The boss 32 perpendicularly projects from the second flat surface of the flat plate 2.

The opposite ends of the metal plate 4 perpendicularly project from the second flat surface of the flat plate 2 along the outer wall surfaces of the respective shielding plates 31. The opposite ends of the metal plate 4 are exposed to the outside to cover at least parts of the outer wall surfaces of the shielding plates 31.

In the carbon fiber reinforced shaped product of the embodiment, a shield portion, such as a shielding plate, can be formed more easily than in the prior art. Further, by, for example, exposing the metal plate on the outer wall surfaces of the shielding plates, stable conduction can be achieved. Also, by imparting a function as a rib and a function as a shielding plate to a projection, shielding plate(s) can be partially reduced.

In accordance with one embodiment, a product including the carbon fiber reinforced shaped product according to one or more embodiments is provided. This product includes an electronic device. The electronic device may be a notebook PC. The embodiment can provide a notebook PC that includes the carbon fiber reinforced shaped product as, for example, a housing forming the notebook PC, a member belonging to the housing, and/or a part of the member belonging to the housing.

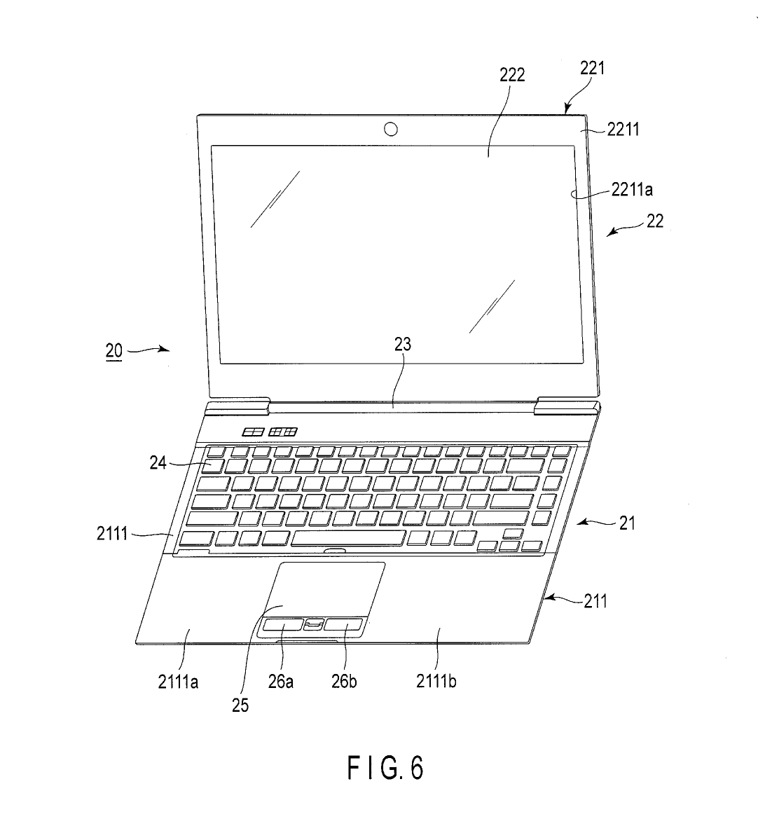

FIG. 6 is a perspective view of an example of a notebook PC as an article provided with a carbon fiber reinforced shaped product according to the embodiment, showing a state in which the display unit of the PC is open.

A notebook PC 20 shown in FIG. 6 comprises a main unit 21, and a display unit 22 openably and closably connected to the rear end of the main unit 21 by a hinge 23.

The display unit 22 comprises a display housing 221 formed of a front wall 2211 and a rear wall (not shown), and a display panel 222 received in the display housing 221. The display panel 222 is exposed in wide opening 2211a formed in the front wall 2211 of the display housing 221.

The main unit 21 comprises a housing 211 formed of an upper wall 2111 and a lower wall (not shown). A main board (not shown) is installed in the housing 211.

A keyboard 24 is mounted on the upper wall 2111 of the main unit 21. The portion (keyboard mounting portion) of the upper wall 2111, in which the keyboard 24 is mounted, is depressed in the housing 211.

The portion of the upper wall 2111 positioned in front of the keyboard mounting portion constitutes left and right palmrests 2111a and 2111b. A touchpad 25 is provided between left and right palmrests 2111a and 2111b, and is operated by left and right touchpad buttons 26a and 26b. The portion of the upper wall 2111 excluding the touchpad 25 and touchpad buttons 26a and 26b is formed integral as one body.

The housing 221 of the display unit and the housing 211 of the main unit can be made of magnesium or an alloy thereof (for example, AZ91 alloy).

For instance, the carbon fiber reinforced shaped product of the embodiment is incorporated in the notebook PC 20 as bosses, ribs, claws and/or shield portions necessary for constituting the notebook PC 20. More specifically, it can constitute a boss, a rib, a claw or a shield portion extending along the inner wall of the housing 211 of the main unit 21 or the display housing 221 of the display unit 22. It may be also included in a member belonging to the housing 211 or the display housing 221, for example, in a cover member attached thereto.

A description will be given of an example.

### EXAMPLE

The lower wall of the main unit housing of the notebook PC, which includes a boss having a structure as shown in FIG. 1, was produced.

A first die and a second die, which provide a shape-forming cavity of a shape corresponding to the lower wall when they are engaged with each other, were prepared. The second die has a projection-forming cavity corresponding to the shape of a boss. By thermal press molding using these dies, the lower wall of the main unit housing of a notebook PC, which has a boss, was produced. The lower wall is an example of the carbon fiber reinforced shaped product of the embodiment, which has a flat plate, a boss formed of a projection on the second flat surface of the flat plate, and a metal plate buried in the flat plate.

The thus-produced carbon fiber reinforced shaped product had no sink marks on the second flat surface of the flat plate opposing the boss.

Except for the lower wall, the notebook PC was produced by a known technique.

The above-described manufacturing method can provide a carbon fiber reinforced shaped product according to the embodiment. The carbon fiber reinforced shaped product of the embodiment comprises a metal plate that covers a flat area corresponding to a projection. Accordingly, a carbon fiber reinforced shaped product, in which no sink marks are formed on the second flat surface opposing the projection, can be acquired. Further, the metal plate buried in the flat plate imparts a higher rigidity to the carbon fiber reinforced shaped product. This advantage is brought to any of small, medium-size and large electronic devices. Since sink marks can be avoided by a small number of structural elements to thereby provide highly rigid products, the embodiment is especially advantageous to small electronic devices.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A carbon fiber reinforced shaped product comprising:
a flat plate comprising a first flat surface, a second flat surface, and a sheet material comprising a carbon fiber reinforced thermoplastic resin; and
at least one projection projecting from the second flat surface of the flat plate,
wherein
the projection comprises the carbon fiber reinforced thermoplastic resin from the sheet material; and
the flat plate comprises a metal plate provided therein and covering a flat area corresponding to the at least one projection.

2. The product of claim 1, comprising a plurality of projections projecting from the second flat surface of the flat plate, wherein the metal plate covers a plurality of flat areas corresponding to the plurality of projections.

3. The product of claim 1, wherein the flat plate has a thickness of 0.4 mm to 3 mm.

4. The product of claim 1, wherein the carbon fiber reinforced thermoplastic resin of the sheet material comprises 40% to 65% by volume of carbon fiber.

5. The product of claim 1, wherein
the flat plate comprises a first sheet material comprising a carbon fiber reinforced thermoplastic resin, and a second sheet material provided above the first sheet material and comprising a same thermoplastic resin as a thermoplastic resin included in the carbon fiber reinforced thermoplastic resin of the first sheet material; and
the metal plate is provided between the first and second sheet materials.

6. The product of claim 1, wherein
the flat plate comprises a first sheet material comprising the carbon fiber reinforced thermoplastic resin, and a second sheet material provided above the first sheet material and comprising the carbon fiber reinforced thermoplastic resin; and
the metal plate is provided between the first and second sheet materials.

7. The product of claim 1, wherein the metal plate further covers at least part of a side surface of the projection.

8. The product of claim 1, wherein the projection is a rib, a boss, a claw and/or a shield portion.

9. A method of manufacturing a carbon fiber reinforced shaped product comprising a flat plate and at least one projection projecting from a flat surface of the flat plate, the method comprising:
placing a sheet material comprising a carbon fiber reinforced thermoplastic resin into a die having at least one depression corresponding to the at least one projection;
placing a metal plate on the sheet material to cover a flat area of the sheet material corresponding to the at least one depression; and
thermally pressing the sheet material against the die along with the metal plate, and causing part of the carbon fiber reinforced thermoplastic resin to flow from the sheet material into the depression.

10. The method of claim 9, wherein the die comprises a plurality of depressions, and the metal plate covers a plurality of flat areas corresponding to the plurality of depressions.

11. The method of claim 8, wherein the flat plate has a thickness of 0.4 mm to 3 mm.

12. The method of claim 9, wherein the carbon fiber reinforced thermoplastic resin of the sheet material comprises 40 to 65% by volume of carbon fiber.

13. The method of claim 9, wherein the placing the sheet material and the placing the metal plate include placing, into the die, a first sheet material comprising a carbon fiber reinforced thermoplastic resin, placing the metal plate on the first sheet material, and placing, onto the metal plate, a second sheet material comprising a same thermoplastic resin as a thermoplastic resin included in the carbon fiber reinforced thermoplastic resin of the first sheet material.

14. The method of claim 9, further comprising the metal plate covering at least part of a side surface of the projection.

15. The method of claim 9, wherein the projection is a rib, a boss, a claw and/or a shield portion.

16. An electronic device comprising the carbon fiber reinforced shaped product of claim 1.

17. The electronic device of claim 16 being a notebook personal computer.

18. The electronic device of claim 17, comprising a main unit housing and/or a display unit housing, wherein the main unit housing and/or the display unit housing, or a rib, a boss, a claw or a shield plate belonging to the main unit housing and/or the display unit housing, comprises the carbon fiber reinforced shaped product.
